(19) United States
(12) Patent Application Publication
(10) Pub. No.: US 2025/0059390 A1
(43) Pub. Date: Feb. 20, 2025

(54) INKJET RECORDING INK AND INKJET RECORDING APPARATUS

(71) Applicant: KYOCERA DOCUMENT SOLUTIONS INC., OSAKA (JP)

(72) Inventor: AKIFUMI NABE, OSAKA (JP)

(21) Appl. No.: 18/797,453

(22) Filed: Aug. 7, 2024

(30) Foreign Application Priority Data
Aug. 8, 2023 (JP) 2023-129344

(51) Int. Cl. C09D 11/322; B41J 2/175; B41J 2/18

(52) U.S. Cl. CPC C09D 11/322; B41J 2/17596; B41J 2/18

(57) ABSTRACT

An inkjet recording ink includes: a pigment; a binder resin particle; and an aqueous medium. The aqueous medium includes glycolether, a specific organic solvent, and water. The specific organic solvent is a glycol compound having 3 or more and 6 or less carbon atoms. A content ratio of the specific organic solvent is 27.5 mass % or more and 35.5 mass % or less. Shear viscosity of the inkjet recording ink measured at a temperature of 32° C. and a shear rate of 10⁵ s⁻¹ is 5.5 mPa·s or more and 7.0 mPa·s or less. A drying rate of the inkjet recording ink is 20% or more and 40% or less.

### CROSS-REFERENCE TO RELATED PATENT APPLICATION

This application claims the benefit of Japanese Priority Patent Application JP 2023-129344 filed Aug. 8, 2023, the entire contents of which are incorporated herein by reference.

### FIELD OF THE DISCLOSURE

The present disclosure relates to an inkjet recording ink and an inkjet recording apparatus.

### BACKGROUND OF THE DISCLOSURE

Some inkjet recording apparatuses include a circulation recording head as a recording head. Inkjet recording inks to be used in inkjet recording apparatuses including circulation recording heads are desired to have excellent performance to maintain ejection accuracy during continuous printing (ejection stability). In order to meet such a demand, for example, using an inkjet recording ink having high viscosity in an inkjet recording apparatus including a circulation recording head has been proposed (Japanese Patent Application Laid-open No. 2005-178246)

### SUMMARY OF THE DISCLOSURE

However, even the inkjet recording ink disclosed in Japanese Patent Application Laid-open No. 2005-178246 cannot achieve sufficient ejection stability.

In view of the circumstances as described above, it is desirable to provide an inkjet recording ink having excellent ejection stability and an inkjet recording apparatus using this inkjet recording ink.

According to an embodiment of the present invention, there is provided an inkjet recording ink, including: a pigment; a binder resin particle; and an aqueous medium. The aqueous medium includes glycolether, a specific organic solvent, and water. The specific organic solvent is a glycol compound having 3 or more and 6 or less carbon atoms. A content ratio of the specific organic solvent is 27.5 mass % or more and 35.5 mass % or less. Shear viscosity of the inkjet recording ink measured at a temperature of 32° C. and a shear rate of 10⁵ s⁻¹ is 5.5 mPa·s or more and 7.0 mPa·s or less. A drying rate of the inkjet recording ink is 20% or more and 40% or less. The drying rate is obtained by the following formula (1) on the basis of a volume V₀ of an ink droplet of the inkjet recording ink immediately after impact and a volume V₁ of the ink droplet 500 ms after the impact when 100 pL or more and 400 pL of the ink droplet are ejected on a measurement stage at a temperature of 25° C.

Drying rate=100×(volume V₀−volume V₁)/volume V₀ (1)

According to an embodiment of the present invention, there is provided an inkjet recording apparatus, including: an ink; and a circulation recording head that ejects the ink. The ink is the above-mentioned inkjet recording ink.

The inkjet recording ink according to the present disclosure has excellent ejection stability. The inkjet recording apparatus according to the present disclosure has excellent ejection stability of the inkjet recording ink.

These and other objects, features and advantages of the present disclosure will become more apparent in light of the following detailed description of best mode embodiments thereof, as illustrated in the accompanying drawings.

### BRIEF DESCRIPTION OF THE DRAWINGS

FIG. 1 is a diagram showing a main part of an example of an inkjet recording apparatus according to a second embodiment; and

FIG. 2 is a diagram showing a member relating to circulation of an ink in the inkjet recording apparatus shown in FIG. 1.

### DETAILED DESCRIPTION OF THE EXEMPLARY EMBODIMENTS

Embodiments of the present disclosure will be described below. Note that in the following, the measured value of the volume median diameter (D₅₀) is a value measured using a dynamic light scattering particle size distribution analyzer (e.g., “Zetasizer Nano ZS” manufactured by Malvern Panalytical Ltd.), unless otherwise specified. The shear viscosity is a value measured using an image analysis viscometer (e.g., “FLUIDICAM RHEO” manufactured by Formulaction SA). The drying rate is a value measured by the method described in Examples or a method according thereto. In the present specification, acrylic and methacrylic are collectively referred to as “(meth) acrylic” in some cases

### First Embodiment: Inkjet Recording Apparatus

A first embodiment of the present disclosure relates to an inkjet recording ink (hereinafter, referred to as an ink in some cases). The ink according to this embodiment includes: a pigment; a binder resin particle; and an aqueous medium. The aqueous medium includes glycolether, a specific organic solvent, and water. The specific organic solvent is a glycol compound having 3 or more and 6 or less carbon atoms. A content ratio of the specific organic solvent is 27.5 mass % or more and 35.5 mass % or less. Shear viscosity of the ink according to this embodiment measured at a temperature of 32° C. and a shear rate of 10⁵ s⁻¹ (hereinafter, referred to simply as “shear viscosity” in some cases) is 5.5 mPa·s or more and 7.0 mPa·s or less. A drying rate of the ink according to this embodiment is 20% or more and 40% or less. It is favorable that the ink according to this embodiment further includes: a pigment coating resin; and a surfactant.

The drying rate is obtained by the following formula (1) on the basis of a volume V₀ of an ink droplet of the ink according to this embodiment immediately after impact and a volume V₁ of the ink droplet 500 ms after the impact when 100 pL or more and 400 pL of the ink droplet are ejected on a measurement stage at a temperature of 25° C.

Drying rate=100×(volume V₀−volume V₁)/volume V₀ (1)

By having the above-mentioned configuration, the ink according to this embodiment has excellent ejection stability. The reasons for this are presumed to be as follows. The ink according to this embodiment includes, as an aqueous medium, glycolether and a predetermined amount of a specific organic solvent. By having such a composition, the ink according to this embodiment has shear viscosity of 5.5 mPa·s or more and 7.0 mPa·s or less and the drying rate of 20% or more and 40% or less. The ink according to this embodiment has moderately high viscosity (shear viscosity is 5.5 mPa·s or more), which allows the ink droplets to properly gather together when ejected. Further, the viscosity of the ink according to this embodiment is not excessively high (shear viscosity is 7.0 mPa·s or less), which allows the ink to be appropriately supplied to the nozzle of the recording head of the inkjet recording apparatus. As a result, the ink according to this embodiment has excellent basic ejection accuracy.

Here, known inks favorably have a low drying rate from the viewpoint of preventing clogging of the nozzle of the recording head of the inkjet recording apparatus. However, in the known inks, the shear viscosity tends to become excessively high when the drying rate is made low. Since the ink according to this embodiment has a moderately low drying rate (20% or more and 40% or less), it is possible to prevent the shear viscosity from becoming excessively high and prevent clogging of the nozzle. As a result, the ink according to this embodiment has excellent ejection stability.

The uses of the ink according to this embodiment are not particularly limited. However, for example, the ink according to this embodiment can be used for forming images on a permeable recording medium or a non-permeable recording medium. The permeable recording medium has excellent permeability for the ink according to this embodiment. Examples of the permeable recording medium include printing paper and a medium formed by using a fiber as a raw material (e.g., a fabric). Examples of the printing paper include plain paper, copy paper, recycled paper, thin paper, thick paper, and glossy paper.

The non-permeable recording medium has lower permeability for the ink according to this embodiment than the permeable recording medium. In the non-permeable recording medium, the absorption amount of the aqueous medium is, for example, 1.0 g/m² or less. Examples of the non-permeable recording medium include a recording medium formed of a resin, a recording medium formed of a metal, and a recording medium formed of glass. Examples of the recording medium formed of a resin include a resin sheet and a resin film. The resin included in the recording medium formed of a resin is favorably a thermoplastic resin. Specific examples of the resin include polyethylene, polypropylene, polyvinyl chloride, and polyethylene terephthalate (PET). Examples of the recording medium formed of a resin include an OPP film. In the case where an image is formed on the recording medium formed of a resin using the ink according to this embodiment, the surface (print surface) of the recording medium may be subjected to corona treatment.

Since the ink according to this embodiment includes a binder resin particle, images with excellent rubfastness can be formed even on the non-permeable recording medium.

### (Drying Rate)

The drying rate of the ink according to this embodiment is 20% or more and 40% or less, favorably 25% or more and 35% or less. By setting the drying rate of the ink according to this embodiment to 20% or more, it is possible to prevent the shear viscosity from becoming excessively high. By setting the drying rate of the ink according to this embodiment to 40% or less, it is possible to prevent clogging of the nozzle.

### (Shear Viscosity)

The shear viscosity of the ink according to this embodiment is 5.5 mPa·s or more and 7.0 mPa·s or less, favorably 6.0 mPa·s or more and 6.5 mPa·s or less. By setting the shear viscosity of the ink according to this embodiment to 5.5 mPa·s or more and 7.0 mPa·s or less, it is possible to optimize the ejection stability.

### (Pigment)

In the ink according to this embodiment, the pigment forms pigment particles together with, for example, a pigment coating resin. The pigment particles each include, for example, a core including a pigment and a pigment coating resin covering the core. The pigment coating resin is present to be, for example, dispersed in a solvent. From the viewpoint of optimizing the color density, hue, or stability of the ink according to this embodiment, the volume median diameter of the pigment particle is favorably 30 nm or more and 200 nm or less, more favorably 70 nm or more and 130 nm or less.

Examples of the pigment include a yellow pigment, an orange pigment, a red pigment, a blue pigment, a purple pigment, and a black pigment. Examples of the yellow pigment include C.I. Pigment Yellow (74, 93, 95, 109, 110, 120, 128, 138, 139, 151, 154, 155, 173, 180, 185, and 193). Examples of the orange pigment include C.I. Pigment Orange (34, 36, 43, 61, 63, and 71). Examples of the red pigment include C.I. Pigment Red (122 and 202). Examples of the blue pigment include C.I. Pigment Blue (15, more specifically 15:3). Examples of the purple pigment include C.I. Pigment Violet (19, 23, and 33). Examples of the black pigment include C.I. Pigment Black (7).

In the ink according to this embodiment, the content ratio of the pigment is favorably 0.5 mass % or more and 10.0 mass % or less, more favorably 1.5 mass % or more and 4.5 mass % or less. By setting the content ratio of the pigment to 0.5 mass % or more, the ink according to this embodiment is capable of forming images with desired image density. Further, by setting the content ratio of the pigment to 10.0 mass % or less, the fluidity of the ink according to this embodiment can be ensured.

### (Pigment Coating Resin)

The pigment coating resin is a resin soluble in an aqueous medium. Part of the pigment coating resin is present on, for example, the surface of the pigment particle to optimize the dispersibility of the pigment particle. Part of the pigment coating resin is present in, for example, a state of being dissolved in the aqueous medium.

As the pigment coating resin, a styrene-(meth)acrylic resin is favorable. The styrene-(meth)acrylic resin includes a repeating unit derived from at least one monomer of (meth)acrylic acid alkylester and (meth)acrylic acid and a styrene unit. Examples of the (meth)acrylic acid alkylester include methyl (meth)acrylate, ethyl (meth)acrylate, propyl (meth)acrylate, and butyl (meth)acrylate.

In the ink according to this embodiment, the content ratio of the pigment coating resin is favorably 0.1 mass % or more and 4.0 mass % or less, more favorably 0.4 mass % or more and 1.2 mass % or less. By setting the content ratio of the pigment coating resin to 0.1 mass % or more and 4.0 mass % or less, it is possible to further optimize the ejection stability of the ink according to this embodiment.

In the ink according to this embodiment, the content of the pigment coating resin to 100 parts by mass of the pigment is favorably 10 parts by mass or more and 60 parts by mass or less, more favorably 20 parts by mass or more and 30 parts by mass or less. By setting the content of the pigment coating resin to 10 parts by mass or more and 60 parts by mass or less, it is possible to further optimize the ejection stability of the ink according to this embodiment.

### (Binder Resin Particle)

The binder resin particle is present to be dispersed in the aqueous medium. The binder resin particle includes a binder resin. Examples of the binder resin include a urethane resin, a (meth)acrylic resin, a styrene-(meth)acrylic resin, a (meth)acrylic-urethane resin, a polyester resin, and a modified polyolefin resin. The binder resin particle favorably includes a urethane resin as a binder resin. The content ratio of the binder resin in the binder resin particle is favorably 80 mass % or more, more favorably 90 mass % or more, and still more favorably 100 mass %.

The urethane resin is, for example, a copolymer of a diol compound or bisphenol compound and a polyisocyanate.

The volume median diameter (D₅₀) of the binder resin particle is favorably 5 nm or more and 100 nm or less, more favorably 20 nm or more and 65 nm or less.

The content ratio of the binder resin particle in the ink according to this embodiment is favorably 1.0 mass % or more and 10.0 mass % or less, more favorably 2.0 mass % or more and 6.0 mass % or less. By setting the content ratio of the binder resin particle to 1.0 mass % or more, the ink according to this embodiment is capable of optimizing the rubfastness of a formed image and adhesion of the formed image to the recording medium. By setting the content ratio of the binder resin particle to 10.0 mass % or less, it is possible to further optimize the ejection stability of the ink according to this embodiment.

### (Surfactant)

The surfactant optimizes the compatibility and dispersion stability of each component included in the ink according to this embodiment. Further, the surfactant optimizes the permeability (wettability) of the ink according to this embodiment to the recording medium. Examples of the surfactant include a nonionic surfactant.

Examples of the nonionic surfactant include an acetylene glycol surfactant (surfactant including an acetylene glycol compound), a silicone surfactant (surfactant including a silicone compound), and a fluorosurfactant (surfactant including a fluoropolymer or a fluorine-containing compound). Examples of the acetylene glycol surfactant include an ethylene oxide adduct of acetylene glycol and a propylene oxide adduct of acetylene glycol. The ink according to this embodiment favorably includes an acetylene glycol surfactant as a surfactant.

The content ratio of the surfactant in the ink according to this embodiment is favorably 0.05 mass % or more and 2.0 mass % or less, more favorably 0.3 mass % or more and 0.7 mass % or less.

### (Aqueous Medium)

The aqueous medium includes glycolether, a specific organic solvent, and water. The aqueous medium may function as a solvent or a dispersion medium. In the aqueous medium, the total content ratio of glycolether, the specific organic solvent, and water is favorably 90 mass % or more, more favorably 100 mass %.

In the ink according to this embodiment, the content ratio of the aqueous medium is favorably 80.0 mass % or more and 97.0 mass % or less, more favorably 90.0 mass % or more and 96.0 mass % or less.

### (Water)

In the ink according to this embodiment, the content ratio of water is favorably 30.0 mass % or more and 70.0 mass % or less, more favorably 42.0 mass % or more and 50.0 mass % or less, and still more favorably 45.0 mass % or more and 48.0 mass % or less.

### (Glycolether)

Examples of the glycolether includes diethylene glycol diethylether, diethylene glycol monobutylether, ethylene glycol monomethylether, ethylene glycol monobutylether, diethylene glycol monomethylether, diethylene glycol monoethylether, diethylene glycol diethylether, triethylene glycol monomethylether, triethylene glycol monoethylether, triethylene glycol monobutylether, propylene glycol monomethylether, and dipropylene glycol monomethylether. As the glycolether, triethylene glycol monobutylether or dipropylene glycol monomethylether is favorable.

In the ink according to this embodiment, the content ratio of glycolether is favorably 10.0 mass % or more and 20.0 mass % or less, more favorably 14.0 mass % or more and 16.0 mass % or less. As the content ratio of glycolether increases, the shear viscosity of the ink according to this embodiment tends to increase and the drying rate tends to decrease. By setting the content ratio of glycolether to 10.0 mass % or more and 20.0 mass % or less, the shear viscosity and the drying rate of the ink according to this embodiment can be easily adjusted to the above-mentioned range.

### (Specific Organic Solvent)

The specific organic solvent is a glycol compound having 3 or more and 6 or less carbon atoms. Examples of the specific organic solvent include 1,2-propanediol, 3-methyl-1,3-butanediol, 1,2-pentanediol, 2-methyl-1,3-propanediol, 1,3-propanediol, dipropylene glycol, 1,5-pentanediol, and 3-methyl-1,5-pentanediol. As the specific organic solvent, 1,2-propanediol or 1,3-propanediol is favorable.

In the ink according to this embodiment, the content ratio of the specific organic solvent is 27.5 mass % or more and 35.5 mass % or less, favorably 29.0 mass % or more and 33.0 mass % or less. As the content ratio of the specific organic solvent increases, the shear viscosity of the ink according to this embodiment tends to increase and the drying rate tends to decrease. By setting the content ratio of the specific organic solvent to 27.5 mass % or more and 35.5 mass % or less, the shear viscosity and the drying rate of the ink according to this embodiment can be easily adjusted to the above-mentioned range.

The aqueous medium may further include a different water-soluble organic solvent other than glycolether and the specific organic solvent (hereinafter, referred to as a different water-soluble organic solvent in some cases). Examples of the different water-soluble organic solvent include a glycol compound having 2 or less carbon atoms, a glycol compound having 7 or more carbon atoms, a lactam compound, a nitrogen-containing compound, an acetate compound, thiodiglycol, glycerin, and dimethylsulfoxide.

### (Other Components)

The ink according to this embodiment may further include, as necessary, known additives (e.g., a dissolution stabilizer, an anti-drying agent, an antioxidant, a viscosity adjustor, a pH adjuster, and an antifungal agent).

### (Method of Producing Ink)

The ink according to this embodiment can be produced by, for example, uniformly mixing, by a stirrer, a pigment dispersion liquid including a pigment, a resin emulsion including a binder resin particle, an aqueous medium, and another component (e.g., a surfactant) to be blended as necessary. In the production of the ink according to this embodiment, after uniformly mixing each component, foreign substances and coarse particles may be removed by a filter (e.g., a filter having a pore size of 5 μm or less).

### (Favorable Composition)

The ink according to this embodiment favorably has one of compositions (i-1) to (i-8) shown in Table 1. Note that in Table 1, the numerical range indicates the content ratio of each component. For example, “2.5-3.5” in the column of the pigment in the composition (i-1) indicates that the content ratio of the pigment is 2.5 mass % or more and 3.5 mass % or less. Abbreviations used in Table 1 will be shown below.
wt %: mass %
TEGMBE: triethylene glycol monobutylether
DPGMME: dipropylene glycol monomethylether
1,2-PD: 1,2-propanediol
1,3-PD: 1,3-propanediol

TABLE 1

| Composition | | | i-1 | i-2 | i-3 | i-4 |
|---|---|---|---|---|---|---|
| Composition | Pigment | | 2.5-3.5 | 2.5-3.5 | 2.5-3.5 | 2.5-3.5 |
| [wt %] | Pigment coating resin | | 0.6-1.0 | 0.6-1.0 | 0.6-1.0 | 0.6-1.0 |
| | Glycolether | TEGMBE | 14.0-16.0 | 14.0-16.0 | 14.0-16.0 | 17.0-19.0 |
| | | DPGMME | — | — | — | — |
| | Specific | 1,2-PD | 27.5-29.0 | 29.0-31.0 | 34.0-35.5 | 29.0-31.0 |
| | organic | 1,3-PD | — | — | — | — |
| | solvent | | | | | |
| | Urethane resin particle | | 3.5-4.5 | 3.5-4.5 | 3.5-4.5 | 3.5-4.5 |
| | Surfactant | | 0.3-0.7 | 0.3-0.7 | 0.3-0.7 | 0.3-0.7 |
| | Ion exchanged water | | Remaining amount | | | |
| | Total | | 100.0 | | | |
| Composition | | | i-5 | i-6 | i-7 | i-8 |
| Composition | Pigment | | 2.5-3.5 | 2.5-3.5 | 2.5-3.5 | 2.5-3.5 |
| [wt %] | Pigment coating resin | | 0.6-1.0 | 0.6-1.0 | 0.6-1.0 | 0.6-1.0 |
| | Glycolether | TEGMBE | 12.0-14.0 | — | 14.0-16.0 | 14.0-16.0 |
| | | DPGMME | — | 14.0-16.0 | — | — |
| | Specific | 1,2-PD | 29.0-31.0 | 29.0-31.0 | — | — |
| | organic | 1,3-PD | — | — | 27.5-29.0 | 34.0-35.5 |
| | solvent | | | | | |

| | | | | |
|---|---|---|---|---|
| Urethane resin particle | 3.5-4.5 | 3.5-4.5 | 3.5-4.5 | 3.5-4.5 |
| Surfactant | 0.3-0.7 | 0.3-0.7 | 0.3-0.7 | 0.3-0.7 |

| | |
|---|---|
| Ion exchanged water | Remaining amount |
| Total | 100.0 |

### Second Embodiment: Inkjet Recording Apparatus

A second embodiment of the present disclosure relates to an inkjet recording apparatus. The inkjet recording apparatus according to this embodiment includes: an ink; and a circulation recording head that ejects the ink. The ink is the ink according to the first embodiment. Since the inkjet recording apparatus according to this embodiment includes the ink according to the first embodiment, it has excellent ejection stability of the ink.

The inkjet recording apparatus according to this embodiment may include only one type of ink or a plurality of types of inks (e.g., four types of inks, i.e., a yellow ink, a cyan ink, a magenta ink, and a black ink). In the case where the inkjet recording apparatus according to this embodiment includes a plurality of types of inks, at least one ink only needs to be the ink according to the first embodiment, but all inks are favorably the inks according to the first embodiment.

Details of the configuration of the inkjet recording apparatus according to this embodiment will be described below with reference to the drawings. Note that the drawings to be referred to schematically show mainly respective components for ease of understanding, and the size, number, and the like of each illustrated component are different from actual ones in some cases for the convenience of drawing creation.

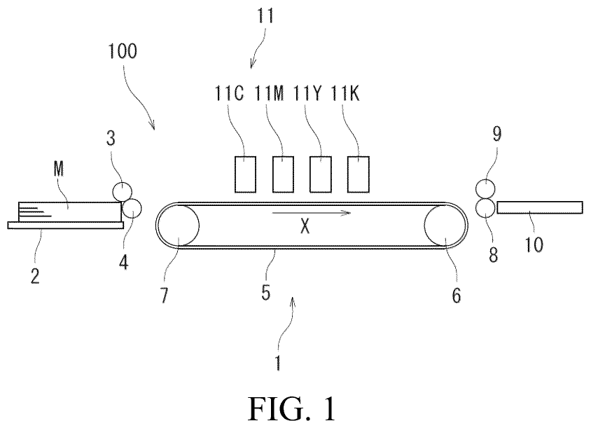

FIG. 1 is a diagram showing a main part of an inkjet recording apparatus 100 that is an example of the inkjet recording apparatus according to this embodiment. As shown in FIG. 1, the inkjet recording apparatus 100 mainly includes a conveying unit 1 and four recording heads 11 (circulation recording heads) that are each a circulation line-type recording head. The inkjet recording apparatus 100 further includes a paper feed tray 2, a paper feed roller 3, a paper feed driven roller 4, a conveyor belt 5, a belt drive roller 6, a belt driven roller 7, an output roller 8, an output driven roller 9, and a paper output tray 10. The conveyor belt 5, the belt drive roller 6, and the belt driven roller 7 constitute part of the conveying unit 1. The paper feed tray 2 is provided on the left end portion in the figure of the inkjet recording apparatus 100. The paper feed tray 2 houses a recording medium M (e.g., a recording sheet or printing paper). The paper feed roller 3 and the paper feed driven roller 4 are provided at one end portion of the paper feed tray 2. The paper feed roller 3 takes out the housed recording medium M one by one, starting from the topmost recording medium M, and feeds the taken paper to the conveyor belt 5. The paper feed driven roller 4 is pressed against the paper feed roller 3 and driven to rotate.

The conveyor belt 5 is rotatably disposed on the downstream side of the paper feed roller 3 and the paper feed driven roller 4 in the paper conveying direction (right side in FIG. 1). The conveyor belt 5 is stretched over the belt drive roller 6 and the belt driven roller 7. The belt drive roller 6 is disposed on the downstream side in the paper conveying direction. The belt drive roller 6 drives the conveyor belt 5. The belt driven roller 7 is disposed on the upstream side in the paper conveying direction. The belt driven roller 7 rotates in accordance with the belt drive roller 6 via the conveyor belt 5. When the belt drive roller 6 is driven to rotate in the clockwise direction, the recording medium M is conveyed in a conveying direction X indicated by an arrow.

Further, the output roller 8 and the output driven roller 9 are provided on the downstream side of the conveyor belt 5 in the conveying direction. The output roller 8 is driven clockwise in the figure to output the recording medium M on which an image has been formed to the outside of the apparatus casing. The output driven roller 9 is pressed against the upper part of the output roller 8 and driven to rotate. The paper output tray 10 is provided on the downstream side of the output roller 8 and the output driven roller 9. The recording medium M output to the outside of the apparatus casing is placed on the paper output tray 10.

The four recording heads 11 include a first recording head 11C, a second recording head 11M, a third recording head 11Y, and a fourth recording head 11K. The first recording head 11C, the second recording head 11M, the third recording head 11Y, and the fourth recording head 11K are disposed at substantially equal intervals above the conveyor belt 5 in this order from the upstream side to the downstream side of the recording medium M in the conveying direction X. The four recording heads 11 are each supported at a height where the distance from the upper surface of the conveyor belt 5 is a predetermined length. The four recording heads 11 each record an image on the recording medium M conveyed on the conveyor belt 5. Inks (a first ink, a second ink, a third ink, and a fourth ink) of four different colors (cyan, magenta, yellow, and black) are supplied to the four recording heads 11. The four recording heads 11 each perform inkjet ejection on the recording medium M in accordance with a predetermined order. As a result, a color image is formed on the recording medium M. The four recording heads 11 is driven by, for example, a piezoelectric system.

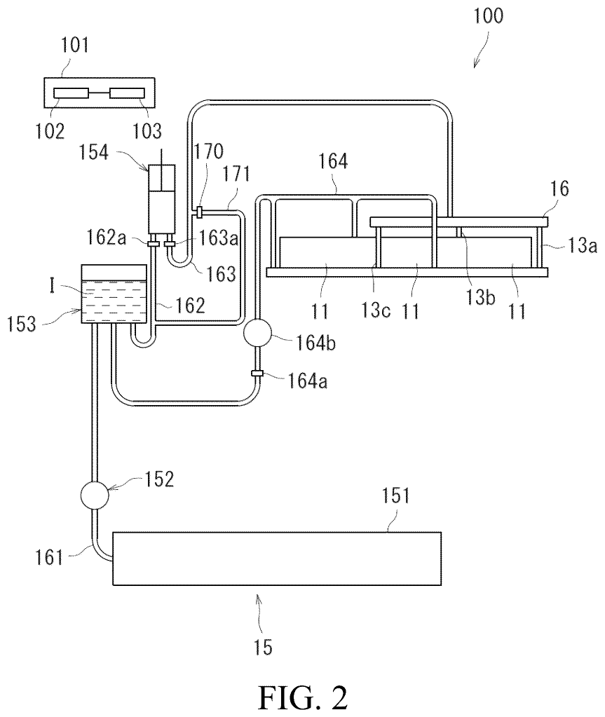

Subsequently, the inkjet recording apparatus 100 will be further described with reference to FIG. 2. FIG. 2 is a diagram showing a member relating to circulation of the ink in the inkjet recording apparatus 100.

As shown in FIG. 2, the inkjet recording apparatus 100 includes the recording head 11 (in detail, one of the first recording head 11C, the second recording head 11M, the third recording head 11Y, and the fourth recording head 11K in FIG. 1), supply pipe members 13a to 13c, an ink supply unit 15, a damper member 16, and a control unit 101. The ink supply unit 15 supplies an ink to the damper member 16. The damper member 16 supplies an ink to the recording head 11 via the supply pipe members 13a to 13c. The control unit 101 controls the ink supply unit 15. Further, the control unit 101 controls the recording head 11.

Note that although omitted for the sake of illustration, the inkjet recording apparatus 100 includes a total of four sets of the supply pipe members 13a to 13c, the ink supply unit 15, and the damper member 16 corresponding to the four recording heads 11 (the first recording head 11C, the second recording head 11M, the third recording head 11Y, and the fourth recording head 11K in FIG. 1).

The ink supply unit 15 includes an ink tank 151, a sub-tank pump 152, a sub-tank 153 (ink storage portion), a diaphragm pump 154 (supply pump), a first pipe 161, a second pipe 162, a third pipe 163, a circulation pipe 164, a first valve 162a, a second valve 163a, a third valve 164a, a circulation pump 164b, a relief valve 170, and a relief pipe 171.

The ink tank 151 houses an ink I. The ink tank 151 is connected to the sub-tank 153 via the first pipe 161. The first pipe 161 distributes the ink I from the ink tank 151 to the sub-tank 153. The sub-tank 153 stores the ink I supplied from the ink tank 151.

The sub-tank pump 152 is disposed to the first pipe 161. For example, the sub-tank pump 152 supplies, when the height of the liquid surface of the ink I in the sub-tank 153 is less than a predetermined value, the ink I stored in the ink tank 151 to the sub-tank 153 in accordance with an instruction of the control unit 101.

In the inkjet recording apparatus 100, the ink I is supplied from the sub-tank 153 to the recording head 11 via the damper member 16. The recording head 11 then ejects at least part of the ink I supplied from the damper member 16 to the recording medium M and discharges the remainder (ink that has not been ejected) of the ink I to the ink supply unit 15. Specifically, the ink I discharged from the recording head 11 is returned to the sub-tank 153. That is, the ink circulates mainly between the sub-tank 153, the damper member 16, and the recording head 11.

The sub-tank 153 is connected to the diaphragm pump 154 via the second pipe 162. The second pipe 162 distributes the ink I from the sub-tank 153 to the diaphragm pump 154. The diaphragm pump 154 is connected to the damper member 16 via the third pipe 163. The third pipe 163 distributes the ink I from the diaphragm pump 154 to the damper member 16.

The diaphragm pump 154 sucks the ink I stored in the sub-tank 153 via the second pipe 162. The diaphragm pump 154 discharges the ink I sucked from the sub-tank 153 to the third pipe 163. Specifically, the diaphragm pump 154 includes a cylinder and a piston. The cylinder stores the ink I sucked from the sub-tank 153. The cylinder is, for example, cylindrical. An inlet and an outlet are formed at the bottom portion of the cylinder. The inlet is connected to the second pipe 162. The outlet is connected to the third pipe 163.

The piston is inserted into the cylinder. The piston moves in a direction away from the bottom portion of the cylinder in accordance with an instruction of the control unit 101. Further, the piston moves in a direction approaching the bottom portion of the cylinder in accordance with an instruction of the control unit 101.

When the piston moves in a direction away from the bottom portion of the cylinder, the ink I is sucked into the cylinder. Specifically, the ink I flows out from the sub-tank 153 into the second pipe 162, and the ink I flows into the cylinder via the second pipe 162.

When the piston moves in a direction approaching the bottom portion of the cylinder, the ink I flows out from the cylinder into the third pipe 163, and the ink I is supplied to the damper member 16 via the third pipe 163.

The first valve 162a is disposed to the second pipe 162. The second valve 163a is disposed to the third pipe 163. The first valve 162a and the second valve 163a open and close in accordance with an instruction of the control unit 101. Specifically, the first valve 162a is open and the second valve 163a is closed while the piston moves in a direction away from the bottom portion of the cylinder. The first valve 162a is closed and the second valve 163a is open while the piston moves in a direction approaching the bottom portion of the cylinder.

The damper member 16 supplies the ink I to the recording head 11 via the supply pipe members 13a to 13c. The damper member 16 has a function of reducing the pressure change of the ink I to be supplied to the recording head 11. The damper member 16 includes at least an ink passage portion through which the ink I passes. The damper member 16 may further include an ink storage chamber for temporarily storing the ink I. In the damper member 16, for example, part of the member forming the ink passage portion and the ink storage chamber is an elastic member (e.g., a resin film). This allows the damper member 16 to reduce the pressure change of the ink I by deformation of the elastic member when the pressure of the ink I inside (the ink passage portion or the ink storage chamber) increases or decreases. As a result, the pressure change of the ink I to be supplied to the recording head 11 is reduced.

The circulation pipe 164 communicates the recording head 11 and the sub-tank 153 with each other. The third valve 164a is disposed to the circulation pipe 164. The third valve 164a opens and closes in accordance with an instruction of the control unit 101. For example, the control unit 101 makes the third valve 164a open when the inkjet recording apparatus 100 forms an image and makes the third valve 164a closed when the inkjet recording apparatus 100 does not form an image. The third valve 164a is a check valve for preventing the ink I from flowing back when, for example, the inkjet recording apparatus 100 does not form an image.

The circulation pump 164b is disposed to the circulation pipe 164. For example, the circulation pump 164b pumps out the ink I inside the circulation pipe 164 to the sub-tank 153. This causes the pressure inside the circulation pipe 164 to be lower than the pressure inside the recording head 11. As a result, the ink I is discharged from the recording head 11 to the sub-tank 153 via the circulation pipe 164.

The control unit 101 includes a storage device 102 and a processing device 103. The storage device 102 stores data and a program. The storage device 102 includes a semiconductor memory such as a random access memory (RAM) and a read only memory (ROM). The storage device 102 may further include a device such as a hard disk drive (HDD). The processing device 103 includes a processor such as a central processing unit (CPU) and a micro processing unit (MPU). The processing device 103 controls the operations of the respective units of the inkjet recording apparatus 100 on the basis of the program stored in the storage device 102.

The relief valve 170 is disposed to the third pipe 163. The relief pipe 171 communicates with the second pipe 162 and the third pipe 163 with each other via the relief valve 170. The relief valve 170 and the relief pipe 171 constitute a relief mechanism. That is, the ink supply unit 15 includes a relief mechanism. The relief valve 170 is, for example, an independent member that is not controlled by the control unit 101. For example, the relief valve 170 is normally kept closed by spring force and is open in the case where the pressure of the ink I inside the third pipe 163 reaches a predetermined value or more. As a result, the relief mechanism discharges, in the case where the pressure of the ink I inside the third pipe 163 has reached the predetermined value or more, the ink I inside the third pipe 163 to the second pipe 162 via the relief pipe 171. In this way, the relief mechanism adjusts the pressure of the ink I inside the third pipe 163 (i.e., the pressure of the ink I to be supplied to the damper member 16) so as not to be the predetermined value or more.

The pressure of the ink I that circulates between the sub-tank 153 and the recording head 11 varies depending on the type of image to be formed by the inkjet recording apparatus 100. Specifically, in the case where the inkjet recording apparatus 100 forms an image with high image density, the recording head 11 consumes a large amount of ink I. This reduces, for example, the pressure of the circulating ink I. Meanwhile, in the case where the inkjet recording apparatus 100 forms an image with low image density, the recording head 11 does not consume a large amount of ink I. This also increases the pressure of the circulating ink I. The pressure change of the circulating ink I is reduced to some extent by adjusting the operation speed of the piston of the diaphragm pump 154, which is not enough. In known inkjet recording apparatuses, a sudden increase or decrease in the ink pressure (particularly, a sudden in crease in the ink pressure) can cause aggregation of the ink. On the other hand, the inkjet recording apparatus 100 is capable of suppressing the sudden increase or decrease in the pressure of the ink I, because it includes the relief mechanism and the damper member 16. As a result, the inkjet recording apparatus 100 is capable of effectively preventing the ink from aggregating.

The circulation flow rate of the recording head 11 (circulation recording head) is favorably 40 mL/min or more and 70 mL/min or less, more favorably 45 mL/min or more and 55 mL/min or less. By setting the circulation flow rate of the recording head 11 to 40 mL/min or more, it is possible to prevent clogging of the nozzle due to drying of the ink present in the vicinity of the nozzle. By setting the circulation flow rate of the recording head 11 to 70 mL/min or less, it is possible to optimize the ejection accuracy of the ink.

Although an example of the inkjet recording apparatus according to this embodiment has been described above, the inkjet recording apparatus according to this embodiment is not limited to that shown in FIGS. 1 and 2.

In FIGS. 1 and 2, the inkjet recording apparatus 100 that includes the four recording heads 11 corresponding to four colors of inks has been described as an example. However, the number of recording heads included in the inkjet recording apparatus according to this embodiment is not particularly limited, and can be, for example, 1 or more and 10 or less, favorably 3 or more and 5 or less. Further, although the inkjet recording apparatus 100 ejects four colors of inks, cyan, magenta, yellow, and black, in this order, the type of ink, combination, and ejection order in the inkjet recording apparatus according to this embodiment are not limited thereto.

Further, in the inkjet recording apparatus according to this embodiment, only the ink and the circulation recording head are essential. Further, the inkjet recording apparatus according to this embodiment may be a multifunction device that further has a function of a scanner, a copier, a printer, or a facsimile machine.

### Examples

Examples of the present disclosure will be described below. However, the present disclosure is not limited to the following Examples.

### (Measurement of Volume Median Diameter)

In Examples, the volume median diameter of resin particles was measured using a dynamic light scattering particle size distribution analyzer (“Zetasizer (registered trademark) Nano ZS” manufactured by Malvern Panalytical Ltd.).

### (Measurement of Shear Viscosity)

The shear viscosity of the ink was measured at a temperature of 32° C. under the following measurement conditions using an image analysis viscometer (“FLUIDICAM RHEO” manufactured by Formulaction SA). As a chip, a glass chip for measuring viscosity (gap: 50 μm) was used. The number of plots was five. In the measurement, while automatically changing the shear rate, the measurement started at the shear rate of 100000 s⁻¹ and ended at the shear rate of 10000 s⁻¹. The other conditions were as follows.

### (Other Conditions)

Microchip: “glass chip for measuring viscosity” manufactured by Formulaction SA
Standard fluid: “5 cP aqueous viscosity standard fluid” manufactured by Formulaction SA

### (Measurement of Drying Rate)

In the measurement of the drying rate of the ink, first, an inkjet droplet observation device (“DropMeasure (registered trademark)-100” manufactured by MICROJET) was filled with the ink to be measured. An ink droplet to be measured was ejected from the head (piezoelectric type) included in the above-mentioned observation device and landed on the measurement stage. At this time, the volume of the ejected liquid droplet was 100 pL or more and 400 pL or less (approximately 250 pL), and the ejection speed was 6 m/sec or more and 8 m/sec or less (approximately 7 m/sec). Next, the changes over time in the volume of the ink droplets landed on the stage were observed using a high-speed camera (“FASTCAM (registered trademark) SA-X2” manufactured by PHOTRON LIMITED). In this way, the volume V₀ of the ink droplet immediately after impact and the volume V₁ of the ink droplet 500 ms after the impact were measured. Next, the drying rate of the ink to be measured was calculated on the basis of the formula (1).

$$Drying rate = 100 \times ( volume {V}_{0} - volume {V}_{1} ) / volume {V}_{0} \qquad ( 1 )$$

Note that although the measurement of the drying rate was repeated a plurality of times for each measurement target, the drying rate was the same value even if the volume of the ejected liquid droplet varied as long as it was within the range of 100 pL or more and 400 pL or less. Similarly, although the measurement of the drying rate was repeated a plurality of times for each measurement target, the draying rate was the same value even if the ejection speed varied as long as it was within the range of 6 m/sec or more and 8 m/sec or less.

### [Preparation of Pigment Dispersion Liquid]

A pigment dispersion liquid (C) including a cyan pigment, a pigment dispersion liquid (Y) including a yellow pigment, a pigment dispersion liquid (M) including a magenta pigment, and a pigment dispersion liquid (K) including a black pigment were prepared by the following method.

### (Pigment Dispersion Liquid (C))

15 parts by mass of a cyan pigment (“HELIOGEN (registered trademark) BLUE D 7088” manufactured by BASF SE, C.I. Pigment Blue 15:3), 10 parts by mass of a pigment coating resin-containing dispersing liquid (“DISPERBYK (registered trademark) 190” manufactured by BYK-Chemie GmbH, non-volatile content: 40%, active ingredient: acrylic resin) and 75 parts by mass of water were mixed and pre-dispersed with a dispersion device to obtain a mixed solution.

Subsequently, the above-mentioned mixed solution was dispersed using a bead mill (“DYNO (registered trademark)-MILL” manufactured by Willy A Bachofen AG) with a volume of 0.6 L filled with 1800 g of zirconia beads having a diameter of 0.1 mm as a dispersion medium. In this way, the pigment dispersion liquid (C) (pigment concentration: 15 mass %, pigment coating resin concentration: 4 mass %) was obtained.

### (Pigment Dispersion Liquid (Y), Pigment Dispersion Liquid (M), and Pigment Dispersion Liquid (B))

The pigment dispersion liquid (Y), the pigment dispersion liquid (M), and the pigment dispersion liquid (B) were prepared in the same manner as that for the preparation of the pigment dispersion liquid (C) except that a yellow pigment, a magenta pigment, and a black pigment described below were used instead of the cyan pigment.
Yellow pigment: “FAST YELLOW 7413” manufactured by Sanyo Color Works, LTD., C.I. Pigment Yellow 74
Magenta pigment: “Red No. 63” manufactured by Dainichiseika Color & Chemicals Mfg. Co., Ltd.
Black pigment: “Printex (registered trademark) 85” manufactured by Orion Engineered Carbons S.A., carbon black

### [Urethane Emulsion]

As a urethane emulsion including urethane resin particles, “SUPERFLEX (registered trademark) 870” manufactured by DKS Co. Ltd. (non-volatile content: 30 mass %, a volume median diameter of the urethane resin particles: 0.03 μm) was used.

### <Preparation of Ink>

Inks (C1) to (C13), (B1), (Y1), and (M1) were prepared by the following method.

### [Ink (C1)]

Ion exchanged water, 20.0 parts by mass of the pigment dispersion liquid (C) (a black pigment: 3.0 parts by mass, a pigment coating resin: 0.8 parts by mass), 15.0 parts by mass of triethylene glycol monobutylether, 27.0 parts by mass of 1,2-propanediol, 13.3 parts by mass of a urethane emulsion (“SUPERFLEX (registered trademark) 870” manufactured by DKS Co. Ltd.) (urethane resin particle: 4.0 parts by mass), and 0.5 parts by mass of a surfactant (“SURFYNOL (registered trademark) 440” manufactured by Nissin Chemical co., ltd., an ethylene oxide adduct of acetylene glycol) were placed in a beaker. The amount of ion exchanged water added was set to the amount (24.2 parts by mass) that would make the total amount of the mixture in the beaker 100.0 parts by mass. The content of the beaker was mixed using a stirrer (“Three-One Motor BL-600” manufactured by Shinto Scientific Co., Ltd.) at the rotation speed of 400 rpm to obtain a mixed solution. The mixed solution was filtered using a filter (pore size of 5 μm) to remove foreign substances and coarse particles included in the mixed solution. In this way, the ink (C1) was obtained.

### [Inks (C2) to (C13), (B1), (Y1), and (M1)]

Inks (C2) to (C13), (B1), (Y1), and (M1) were prepared in the same manner as that for the preparation of the ink (I-1) except that the type and amount of each component were changed as shown in Tables 2 and 3. The inks (C1) to (C13), (B1), (Y1), and (M1) were respectively the inks according to Examples 1 to 11 and Comparative Examples 1 to 5 as shown in Tables 2 and 3.

Note that abbreviations used in Tables 2 and 3 and Table 4 described below are as follows.
wt %: mass %
TEGMBE: triethylene glycol monobutylether
DPGMME: dipropylene glycol monomethylether
1,2-PD: 1,2-propanediol
1,3-PD: 1,3-propanediol
Ex 1 to Ex 11: Example 1 to Example 11
Comp 1 to Comp 5: Comparative Examples 1 to Comparative Example 5

(Table 2)

TABLE 3

| | | | Comp1 | Ex 1 | Ex2 | Ex3 | Comp2 | Ex4 | Ex5 | Ex6 |
|---|---|---|---|---|---|---|---|---|---|---|
| Ink | | | C1 | C2 | C3 | C4 | C5 | B1 | Y1 | M1 |
| Com- | Pigment | Cyan | 3.0 | 3.0 | 3.0 | 3.0 | 3.0 | — | — | — |
| position | | Black | — | — | — | — | — | 3.0 | — | — |
| [wt %] | | Yellow | — | — | — | — | — | — | 3.0 | — |
| | | Magenta | — | — | — | — | — | — | — | 3.0 |
| | Pigment coating | | 0.8 | 0.8 | 0.8 | 0.8 | 0.8 | 0.8 | 0.8 | 0.8 |
| | resin | | | | | | | | | |
| | Glycol | TEGMBE | 15.0 | 15.0 | 15.0 | 15.0 | 15.0 | 15.0 | 15.0 | 15.0 |
| | Ether | DPGMME | — | — | — | — | — | — | — | — |
| | Specific | 1,2-PD | 27.0 | 28.0 | 30.0 | 35.0 | 36.0 | 30.0 | 30.0 | 30.0 |
| | organic | | | | | | | | | |
| | solvent | 1,3-PD | — | — | — | — | — | — | — | — |
| | Urethane resin | | 4.0 | 4.0 | 4.0 | 4.0 | 4.0 | 4.0 | 4.0 | 4.0 |
| | particle | | | | | | | | | |
| | Surfactant | | 0.5 | 0.5 | 0.5 | 0.5 | 0.5 | 0.5 | 0.5 | 0.5 |
| | Ion exchanged water | | Remaining amount | | | | | | | |
| | Total | | 100.0 | | | | | | | |
| Measured | Shear viscosity | | 5.3 | 5.6 | 6.3 | 6.8 | 7.1 | 6.3 | 6.4 | 6.3 |
| value | [mPa · s] | | | | | | | | | |
| | Drying rate [%] | | 42 | 39 | 31 | 22 | 20 | 33 | 32 | 31 |
| | | | Ex7 | Ex8 | Ex9 | Comp3 | Ex10 | Ex11 | Comp4 | Comp5 |
| Ink | | | C6 | C7 | C8 | C9 | C10 | C11 | C12 | C13 |
| Com- | Pigment | Cyan | 3.0 | 3.0 | 3.0 | 3.0 | 3.0 | 3.0 | 3.0 | 3.0 |
| position | | Black | — | — | — | — | — | — | — | — |
| [wt %] | | Yellow | — | — | — | — | — | — | — | — |
| | | Magenta | — | — | — | — | — | — | — | — |
| | Pigment coating | | 0.8 | 0.8 | 0.8 | 0.8 | 0.8 | 0.8 | 0.8 | 0.8 |
| | resin | | | | | | | | | |
| | Glycol | TEGMBE | 18.0 | 13.0 | — | 15.0 | 15.0 | 15.0 | 15.0 | — |
| | Ether | DPGMME | — | — | 15.0 | — | — | — | — | — |
| | Specific | 1,2-PD | 30.0 | 30.0 | 30.0 | — | — | — | — | 30.0 |
| | organic | | | | | | | | | |
| | solvent | 1,3-PD | — | — | — | 27.0 | 28.0 | 35.0 | 36.0 | — |

| | Urethane resin | 4.0 | 4.0 | 4.0 | 4.0 | 4.0 | 4.0 | 4.0 | 4.0 |
|---|---|---|---|---|---|---|---|---|---|
| | particle | | | | | | | | |
| | Surfactant | 0.5 | 0.5 | 0.5 | 0.5 | 0.5 | 0.5 | 0.5 | 0.5 |
| | Ion exchanged water | Remaining amount | | | | | | | |
| | Total | 100.0 | | | | | | | |
| Measured | Shear viscosity | 6.7 | 5.8 | 6.2 | 5.3 | 5.7 | 6.8 | 7.2 | 4.8 |
| value | [mPa · s] | | | | | | | | |
| | Drying rate [%] | 30 | 38 | 33 | 35 | 35 | 24 | 23 | 45 |

### Evaluation

The ejection stability of each of the inks according to Examples 1 to 11 and Comparative Examples 1 to 5 was evaluated by the following method. The evaluation results are shown in Table 4. Note that the evaluation was performed at a temperature of 25° C. and a humidity of 60% RH unless otherwise specified

An evaluation device (tester manufactured by KYOCERA Document Solutions Inc.) that includes at least a circulation recording head and an ink recirculation pump (“recirculation pump CIMS” manufactured by Megnajet) was prepared. The ink recirculation pump corresponds to the ink supply unit in the second embodiment and was designed to supply an ink to be evaluated to the circulation recording head. The circulation recording head was set to eject, as necessary, at least part of the ink supplied from the ink recirculation pump to the recording medium and return the remainder of the supplied ink to the ink recirculation pump. Note that the circulation recording head was set to return, in the case where it is unnecessary to eject the ink (no image is formed), the total amount of the ink supplied from the ink recirculation pump to the ink recirculation pump. The circulation flow rate of the recirculation pump was set as shown in the following Table 4.

As a recording medium, A4 size inkjet matte paper (“Super Fine Paper” manufactured by Seiko Epson Corp.) was used.

A solid image of 150 mm×200 mm was continuously printed on 5000 recording media using the evaluation device. Next, an ink to be evaluated was purged from the circulation recording head of the evaluation device. Next, the ink ejection surface of the circulation recording head of the evaluation device was wiped to clean the circulation recording head. Next, a stripe image formed by a plurality of parallel thin lines was formed on the recording medium using the evaluation device. In the formation of the stripe image, the line width of the thin line was set to one pixel and the interval between adjacent thin lines (line-to-line pitch) was set to three pixels.

Next, the stripe image formed on the recording medium was read using a microscope. In detail, an interval A between a specific thin line a and a thin line b located 16 pixels away from the thin line a was measured at 204 positions. Note that three other thin lines were present between the thin line a and the thin line b. The variation (3σ [unit: μm]) of the measured intervals A was calculated using image processing software (manufactured by KYOCERA Document Solutions Inc.). The calculated variation (3σ) of the intervals A was used as the evaluation value of ejection stability. The ejection stability was judged in accordance with the following criteria.

### (Criteria of Ejection Stability)

A (Good): 3σ is less than 20.
B (Poor): 3σ is 20 or more.
C (Particularly poor): Some nozzles do not eject the ink due to clogging, and 3σ cannot be analyzed.

TABLE 4

| | | Comp1 | | Ex1 | | Ex2 | | Ex3 | | Comp1 | |
|---|---|---|---|---|---|---|---|---|---|---|---|
| Ink | | C1 | | C2 | | C3 | | C4 | | C5 | |
| Circulation | [mL/min] | 40 | 70 | 40 | 70 | 40 | 70 | 40 | 70 | 40 | 70 |
| flow rate | | | | | | | | | | | |
| Ejection | 3σ | 24.7 | 35.1 | 18.6 | 19.8 | 16.8 | 17.1 | 18.8 | 18.2 | — | 32.9 |
| stability | Judgment | B | B | A | A | A | A | A | A | C | B |
| | | Ex4 | | Ex5 | | Ex6 | | Ex7 | Ex8 | Ex9 | Comp3 |
| Ink | | B1 | | Y1 | | M1 | | C6 | C7 | C8 | 09 |
| Circulation | [mL/min] | 40 | 70 | 40 | 70 | 40 | 70 | 50 | 50 | 50 | 50 |
| flow rate | | | | | | | | | | | |
| Ejection | 3σ | 18.0 | 17.9 | 17.5 | 18.2 | 17.6 | 18.1 | 19.0 | 19.1 | 18.7 | 22.3 |
| stability | Judgment | A | A | A | A | A | A | A | A | A | B |

| | | Ex10 | Ex11 | Comp4 | Comp5 |
|---|---|---|---|---|---|
| Ink | | C10 | C11 | C12 | C13 |
| Circulation | [mL/min] | 50 | 50 | 50 | 50 |
| flow rate | | | | | |
| Ejection | 3σ | 17.9 | 18.4 | 23.4 | 26.2 |
| stability | Judgment | A | A | B | B |

As shown in Tables 2 to 4, each of the inks (C2) to (C4), (B1), (Y1), (M1), (C6) to (C8), and (C10) to (C11) according to Examples 1 to 9 included a pigment, a binder resin particle, and an aqueous medium. The aqueous medium included glycolether, a specific organic solvent, and water. The content ratio of the specific organic solvent was 27.5 mass % or more and 35.5 mass % or less. The shear viscosity of each of the inks according to Examples was 5.5 mPa·s or more and 7.0 mPa·s or less. The drying rate of each of the inks according to Examples was 20% or more and 40% or less. Each of the inks according to Examples had excellent ejection stability.

On the other hand, the ink (C1) according to Comparative Example 1 and the ink (C9) according to Comparative Example 3 each had an insufficient content ratio of the specific organic solvent. This made the ink (C1) and the ink (C9) have excessively low shear viscosity and an excessively high drying rate. As a result, the ejection stability of each of the ink (C1) and the ink (C9) was evaluated as poor.

The ink (C5) according to Comparative Example 2 and the ink (C12) according to Comparative Example 4 has an excessively high content ratio of the specific organic solvent. This made the ink (C5) and the ink (C12) have excessively high shear viscosity and an excessively low drying rate. As a result, the ejection stability of each of the ink (C5) and the ink (C12) was evaluated as poor.

The ink (C13) according to Comparative Example 5 included no glycolether. This made the ink (C13) have excessively low shear viscosity and an excessively high drying rate. As a result, the ejection stability of the ink (C13) was evaluated as poor.

It should be understood by those skilled in the art that various modifications, combinations, sub-combinations and alterations may occur depending on design requirements and other factors insofar as they are within the scope of the appended claims or the equivalents thereof.

What is claimed is:

1. An inkjet recording ink, comprising:
a pigment;
a binder resin particle; and
an aqueous medium,
the aqueous medium including glycolether, a specific organic solvent, and water,
the specific organic solvent being a glycol compound having 3 or more and 6 or less carbon atoms,
a content ratio of the specific organic solvent being 27.5 mass % or more and 35.5 mass % or less,
shear viscosity of the inkjet recording ink measured at a temperature of 32° C. and a shear rate of 10⁵ s⁻¹ being 5.5 mPa·s or more and 7.0 mPa·s or less,
a drying rate of the inkjet recording ink being 20% or more and 40% or less,
the drying rate being obtained by the following formula (1) on a basis of a volume V₀ of an ink droplet of the inkjet recording ink immediately after impact and a volume V₁ of the ink droplet 500 ms after the impact when 100 pL or more and 400 pL of the ink droplet are ejected on a measurement stage at a temperature of 25° C.;
Drying rate=100×(volume V₀−volume V₁)/volume V₀ (1).

2. The inkjet recording ink according to claim 1, wherein
the specific organic solvent contains at least one of 1,2-propanediol, 3-methyl-1,3-butanediol, 1,2-pentanediol, 2-methyl-1,3-propanediol, 1,3-propanediol, dipropylene glycol, 1,5-pentanediol, or 3-methyl-1,5-pentanediol.

3. The inkjet recording ink according to claim 2, wherein
the specific organic solvent contains at least one of 1,2-propanediol or 1,3-propanediol.

4. The inkjet recording ink according to claim 1, wherein
the glycolether contains at least one of triethylene glycol monobutylether or dipropylene glycol monomethylether.

5. The inkjet recording ink according to claim 1, wherein
the binder resin particle contains a urethane resin.

6. The inkjet recording ink according to claim 1, wherein
a content ratio of the glycolether is 10.0 mass % or more and 20.0 mass % or less.

7. The inkjet recording ink according to claim 1, wherein
a content ratio of the binder resin article is 2.0 mass % or more and 6.0 mass % or less.

8. The inkjet recording ink according to claim 1, wherein
a content ratio of the water is 42.0 mass % or more and 50.0 mass % or less.

9. An inkjet recording apparatus, comprising:
an ink; and
a circulation recording head that ejects the ink,
the ink being the inkjet recording ink according to claim 1.

10. The inkjet recording apparatus according to claim 9, wherein
a circulation flow rate of the circulation recording head is 40 mL/min or more and 70 mL/min or less.
